(19) United States
(12) Patent Application Publication
(10) Pub. No.: US 2019/0244732 A1
(43) Pub. Date: Aug. 8, 2019

(54) Component for Protecting Against Overvoltages and the Use Thereof with Two Varistors and an Arrestor in a Single Component

(71) Applicant: TDK Electronics AG, München (DE)

(72) Inventor: Robert Hoffmann, Berlin (DE)

(21) Appl. No.: 16/319,222

(22) PCT Filed: Jul. 7, 2017
(86) PCT No.: PCT/EP2017/067120

§ 371 Date: Jan. 18, 2019

(30) Foreign Application Priority Data
Jul. 19, 2016 (DE) 10 2016 113 267.5

(51) Int. Cl. H01C 7/12; H01T 1/16; H01T 4/04; H02H 9/06; H02H 9/04

(52) U.S. Cl. CPC H01C 7/12; H01T 1/16; H02H 9/041; H02H 9/06; H01T 4/04

(57) ABSTRACT

A component for protecting against overvoltages is disclosed. In an embodiment a component for protecting against overvoltages includes a surge arrester, a first varistor, a second varistor, wherein the surge arrester, the first varistor and the second varistor are combined in a single component, a first connecting element electrically conductively connected to the first varistor and a second connecting element electrically conductively connected to the second varistor.

This patent application is a national phase filing under section 371 of PCT/EP2017/067120, filed Jul. 7, 2017, which claims the priority of German patent application, 102016113267.5 filed Jul. 19, 2016, each of which is incorporated herein by reference in its entirety.

### TECHNICAL FIELD

The present invention relates to a component for protecting against overvoltages. The present invention furthermore relates to the use of a component for protecting against overvoltages.

### BACKGROUND

Overvoltage protection components may be used as short-circuit switches in the case of an overvoltage. It is thereby possible to avoid damage to conductors and devices due to overvoltage.

### SUMMARY OF THE INVENTION

Embodiments provide an improved component for protecting against overvoltages. Further embodiments provide a method for using an improved component for protecting against overvoltage.

According to one aspect, a component is provided. The component is configured for protecting against overvoltages. The component is a combined component. The component comprises a surge arrester, in particular a gas-discharge surge arrester. The component comprises a first varistor and a second varistor. Preferably, the varistors are connected in series. The varistors are, for example, multilayer varistors. The varistors comprise a ceramic base material, preferably zinc oxide.

The component comprises a first connecting element and a second connecting element, for example, wires. The first varistor is electrically conductively connected to the first connecting element. The second varistor is electrically conductively connected to the second connecting element. The component combines the varistors and the surge arrester in a single component. In this way, an easy-to-use component is provided for protecting against overvoltages, comprising subcomponents which are optimally matched to one another. Due to the combination of the three subcomponents, the component is compact and easy to install.

According to an embodiment, the surge arrester is arranged between the varistors. The varistors are arranged directly adjacent to the surge arrester. Preferably, the varistors are soldered to the surge arrester, for example, by means of soft solder. In this way, a compact, stable, and reliable component is provided.

According to an embodiment, the component is designed and arranged to compensate for overvoltages between the first connecting element and the second connecting element. For example, the first connecting element corresponds to the line conductor/the phase, and the second connecting element corresponds to the neutral conductor, or vice-versa. Furthermore, the component is designed and arranged to compensate for overvoltages between the first connecting element and a protective ground conductor, and/or between the second connecting element and the protective ground conductor. In this way, it is possible to effectively compensate for overvoltages via the component.

According to an embodiment, the surge arrester comprises a first outer electrode and a second outer electrode. The first varistor is electrically conductively connected to the first outer electrode. The second varistor is electrically conductively connected to the second outer electrode. The surge arrester comprises a central electrode arranged between the outer electrodes. The surge arrester furthermore comprises a discharge space for enabling an electrical discharge between the first outer electrode and the central electrode, and/or between the second outer electrode and the central electrode, in the case of overvoltage. In this way, is possible to effectively compensate for overvoltages occurring between the line conductor and the protective ground conductor, and between the neutral conductor and the protective ground conductor.

According to an embodiment, the component comprises a contact element. The contact element comprises, for example, a short-circuit bridge. The contact element is designed and arranged to compensate for an overvoltage occurring between the first connecting element and the second connecting element. In this way, it is possible to compensate effectively for overvoltages occurring between the line conductor and the neutral conductor.

According to an embodiment, the surge arrester comprises an insulator. The insulator is designed and arranged to prevent a flashover from the contact element to the central electrode. The insulator is formed between the contact element and the central electrode. The insulator is, for example, disk-shaped. Preferably, the insulator comprises plastic.

Alternatively, a flashover between the contact element and the central electrode may also be prevented via an increase in the vertical spacing between the contact element and the central electrode. Preferably, the maximum vertical spacing in this case is approximately 2 mm. In the case of integration of an insulator into the component, the spacing between the contact element and the central electrode may be correspondingly decreased.

According to an embodiment, the surge arrester comprises at least one insulating element, preferably two or four insulating elements. The insulating element is designed and arranged to prevent an electrically conductive connection between the outer electrodes and/or between the respective outer electrode and the central electrode. The insulating element is at least partially arranged in a gap between the respective outer electrode and the central electrode. The insulating element comprises a ceramic, preferably aluminum oxide.

According to an embodiment, the component comprises an insulating casing. The casing preferably completely surrounds the component, with the exception of the connecting elements. In particular, the surge arrester and the varistors are arranged together inside the insulating casing. The insulating casing preferably comprises a powder coating. By means of the insulating casing, the component can be effectively electrically and mechanically insulated towards the outside.

According to another aspect, the use of a component for protecting against overvoltages is described. The component is preferably used as input protection for a plurality of devices, for example, 230 V power supplies. Preferably, the component described above is provided for the described use. All features which have been described in connection with the component also apply to the use, and vice-versa.

By means of the component, a first varistor, a second varistor, and a surge arrester are combined in a single component. Thus, the use of an easy-to-use and easy-to-install overvoltage protection component is described, of which the individual subcomponents are optimally matched to one another. As a result, effective and simple protection from overvoltages may be obtained.

### BRIEF DESCRIPTION OF THE DRAWINGS

The drawings depicted below are not to be interpreted as being true to scale. Rather, in order to improve the illustration, individual dimensions may be depicted as being increased, decreased, or even skewed.

Elements which are identical to one another or which assume the same function are depicted having identical reference characters.

The following are shown:

FIG. 1 shows an electric circuit for protecting against overvoltages, according to prior art;

FIG. 2 shows a component for protecting against overvoltages, according to a first embodiment;

FIG. 3 shows a cross-sectional view of a subarea of the component according to FIG. 2;

FIG. 4 shows a perspective view of the subarea according to FIG. 3;

FIG. 5 shows a cross-sectional view of a component for protecting against overvoltages, according to an additional embodiment; and

FIG. 6 shows a perspective view of the component according to FIG. 5.

### DETAILED DESCRIPTION OF ILLUSTRATIVE EMBODIMENTS

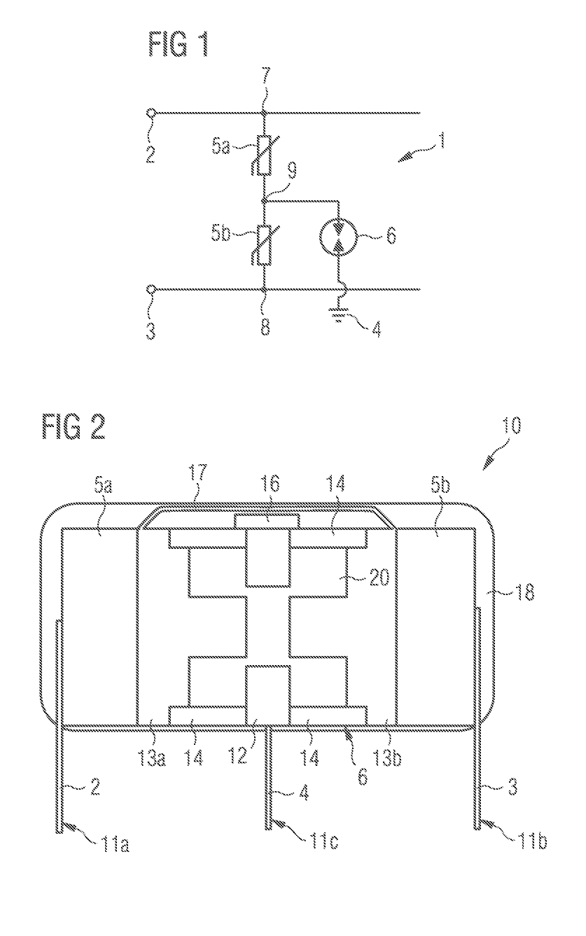

FIG. 1 shows an electric circuit 1 for protecting against overvoltages, according to prior art. The circuit 1 comprises three discrete, or rather separate, components. The circuit 1 comprises in particular a first varistor 5a and a second varistor 5b, as well as a surge arrester 6.

The varistors 5a, 5b are connected in series. The first varistor 5a is electrically conductively connected via a node 7 to the line conductor (phase) 2. The second varistor 5b is electrically conductively connected via a node 8 to the neutral conductor 3. The two varistors 5a, 5b are electrically conductively connected via another node 9 to the surge arrester 6. The surge arrester 6 is preferably a gas-discharge surge arrester. The surge arrester 6 is electrically conductively connected to the protective ground conductor 4.

The circuit 1 protects against overvoltages which occur either between the line conductor 2 and the neutral conductor 3, or between the line conductor 2 or the neutral conductor 3 and the protective ground conductor 4. In the case of an overvoltage between the line conductor 2 and the neutral conductor 3, the two varistors 5a, 5b which are connected in series limit the voltage. In the case of an overvoltage between the line conductor 2 and the protective ground conductor 4, or the neutral conductor 3 and the protective ground conductor 4, the surge arrester 6 strikes, and the varistor 5a, 5b, which is then connected in series, limits the follow current until the surge arrester 6 extinguishes. The surge arrester 6 generally has a very high sparkover voltage so that the overvoltage protection does not spark over during production-related insulation tests. Lower sparkover voltages are possible if the insulation tests permit this. For example, the sparkover voltage is between 1500 V and 7500 V, for example, 3600 V.

The problem with such input protection is the matching of the components (varistors, surge arrester) to one another. Said components must be matched to the network voltage, the expected interference load, the insulation test voltage level, and the space requirements.

In connection with FIGS. 2 to 6, a component 10 is described which effectively protects against overvoltages and in which the individual subcomponents are optimally matched to one another and are adapted to external requirements (installation situation, insulation test).

FIG. 2 shows a component 10 for protecting against overvoltages, accord to a first embodiment. The component 10 is cylinder-shaped (see FIG. 6). The component 10 is a combined component. The component 10 combines the above-described subcomponents in a single component. In particular, the component 10 comprises a first varistor 5a, a second varistor 5a, and a surge arrester 6.

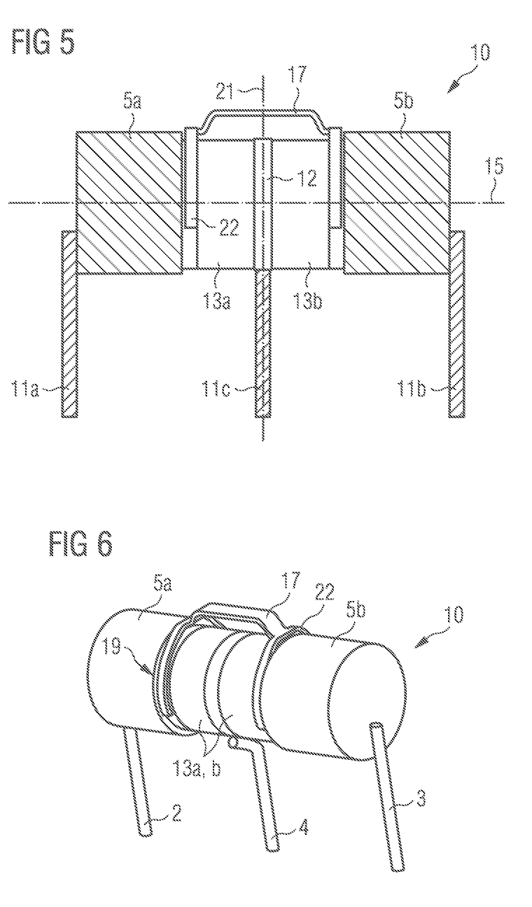

The varistors 5a, 5b are disk-shaped or plate-shaped. The varistors 5a, 5b are preferably multilayer varistors. Preferably, the varistors 5a, 5b comprise zinc oxide (ZnO) as a ceramic base material. The first varistor 5a is electrically conductively connected to a first connecting element 11a (here, the line conductor 2). The second varistor 6b is electrically conductively connected to a second connecting element 11b (here, the neutral conductor 3). Of course, the first varistor 5a may also be electrically conductively connected to the neutral conductor 3, and the second varistor 5b may be electrically conductively connected to the line conductor 2. The connecting elements 11a, 11b comprise, for example, connecting wires. The connecting elements 11a, 11b are preferably soldered to the respective varistor 5a, 5b, for example, a side face of the respective varistor 5a, 5b, (FIGS. 5 and 6).

The surge arrester 6 is embedded between the varistors 5a, 5b. In particular, a side face of the respective varistor 5a, 5b is preferably directly adjacent to a side face of the surge arrester 6. The varistors 5a, 5b are soldered to the surge arrester 6, preferably by means of soft solder (see soft soldering point 19, FIG. 6).

The surge arrester 6 comprises three electrodes. The surge arrester 6 comprises a first outer electrode 13a and a second outer electrode 13b. The surge arrester 6 comprises a central electrode 12 which is arranged between the outer electrodes 13a, 13b. The first outer electrode 13a is electrically conductively connected to the first varistor 5a. The second outer electrode 13b is electrically conductively connected to the second varistor 5b. The central electrode 12 is electrically conductively connected to a third connecting element 11c, preferably a connecting wire. The third connecting element 11a presently constitutes the protective ground conductor 4. Preferably, the outer electrodes 13a, 13b and the central electrode 12 comprise copper or an iron-nickel alloy.

A gas-filled cavity 20 is formed between the outer electrodes 13a, 13b. The cavity 20 is preferably filled with a noble gas. Alternatively, the gas may be air or a gas mixture. The gas mixture may comprise one or a plurality of the elements argon, neon, and hydrogen. The central electrode 12 extends from an upper side and a lower side of the surge arrester 6 into the cavity 20.

The gas-filled cavity 20 may in particular be used as a spark gap. Accordingly, the gas-filled cavity 20 acts in an insulating manner, if a voltage is present between the outer electrodes 13a, 13b and the central electrode 12 which does not exceed a predetermined breakdown voltage. If the breakdown voltage is exceeded, the gas arranged in the gas-filled cavity 20 is ionized, and the respective outer electrode 13a, 13b is conductively connected to the central electrode 12 via the spark gap now formed in the cavity 20. A short circuit can thus occur. As a result of this short circuit being triggered in the component 10, a circuit arrangement which is connected to the component 10 can be protected from damage.

If an overvoltage occurs between the first connecting element 11a (line conductor 2) and the third connecting element 11c (protective ground conductor 4), automatic striking of the other side (between the second connecting element 11b and the third connecting element 11c) also occurs, and vice-versa. As a result, even small overvoltages, which would not have independently resulted in striking of the spark gap, may be dissipated. Thus, both the line conductor 2 and the neutral conductor 3 are effectively protected from overvoltage at all times.

The component 10 furthermore comprises a contact element 17, preferably a short-circuit bridge. The contact element 17 is stirrup-shaped. The contact element 17 comprises copper, iron, and/or nickel.

The contact element 17 is designed to establish an electrically conductive connection between the varistors 5a, 5b. In particular, the contact element 17 compensates for overvoltages occurring between the first connecting element 11a and the second connecting element 11b. In other words, with the aid of the contact element 17, it is possible to compensate for a voltage occurring between the line conductor 2 and the neutral conductor 3 (see FIG. 1).

Preferably, the contact element 17 is attached, in particular clipped to the outer electrodes 13a, 13b (see FIGS. 5 and 6). For this purpose, the contact element 17 preferably comprises two brackets 22 which are arranged at, for example, soldered to, the ends of the contact element 17. However, the brackets 22 and the contact element 17 may also be designed as one piece.

The brackets 22 are, for example, semicircular. The brackets 22 are designed to be flexible or bendable. The brackets 22 are elastically deformable. The brackets 22 are designed to be elastic in a radial direction. The brackets 22 are placed on the component 10, in particular at the position of the outer electrodes 13a, 13b, and moved along the component 10 in a vertical direction, wherein the brackets 22 and in particular their ends move radially outwardly. As soon as the brackets 22 have reached their end position and at least partially surround the outer area of the respective outer electrode 13a, 13b, the brackets 22 have relaxed back into the radially inward direction, and the contact element 17 is clipped (FIG. 6).

In this embodiment, an insulating element, or rather, an insulator 16, is arranged between the contact element 17 and the central electrode 12. The insulator 16 may, for example, comprise plastic. With the aid of the insulator 16, a flashover from the contact element 17 to the central electrode 12 may be prevented.

Furthermore, an insulating element 14, preferably a ceramic, is formed in each case between the respective outer electrode 13a, 13b and the central electrode 12. The insulating element 14 is disk-shaped. The insulating element 14 is, for example, a ceramic disk. The ceramic may comprise aluminum oxide. With the aid of the insulating element 14, an electrical connection is prevented between the electrodes 13a, 13b, and 12.

The component 10 is furthermore surrounded by an insulating casing 18. The individual subcomponents of the component 10 are all arranged together inside the insulating casing 18, with the exception of the connecting elements 11a, 11b, 11c. For making contact with the component 10, the connecting elements 11a, 11b and 11c penetrate the casing 18 at predetermined positions, as depicted in FIG. 2. The insulating casing preferably comprises a powder coating. The insulating casing 18 is used for the electrical and mechanical insulation of the component 10 towards the outside.

The component 10 is designed to effectively compensate for overvoltages which occur. In particular, said component is designed to withstand loads of several kA 8/20 μs per side.

The component 10 combines the subcomponents shown in FIG. 1 for overvoltage compensation for the first time in one component. Due to the integration of the individual subcomponents into one component, the component 10 is easy to use. Furthermore, said component is characterized by its space-saving construction and its simple installation.

The component has, for example, a length or horizontal extension of less than or equal to 3 cm, for example, 2.8 cm. The height or vertical extension of the component to connecting elements 11a, 11b, 11c is, for example, less than or equal to 2.5 cm, for example, 2.2 cm. Without connecting elements 11a, 11b, 11c, the height preferably amounts to less than 1.5 cm, for example, 1 cm. A greater length and height for the component is also conceivable. For example, the length may be less than or equal to 5 cm. The height of the connecting elements 11a, 11b, 11c may, for example, be less than or equal to 2 cm.

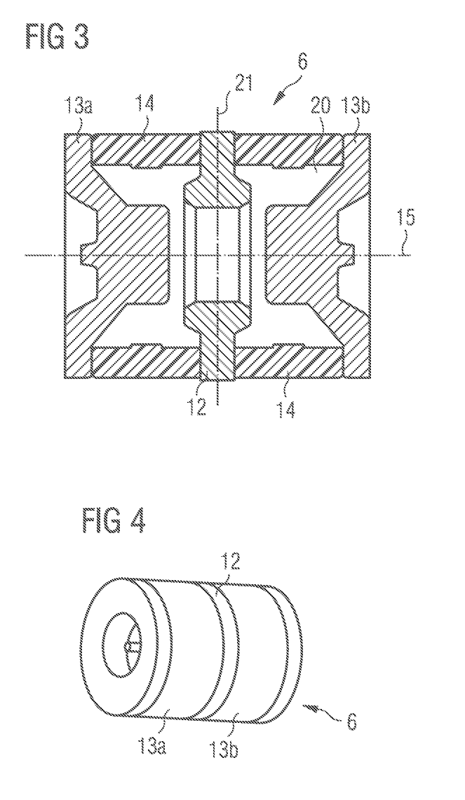

FIGS. 3 and 4 show a cross-sectional view and a perspective view of a subarea of the component 10 according to FIG. 2. In particular, the figures show the surge arrester 6 comprising the two outer electrodes 13a, 13b, the central electrode 12, and the insulating elements 14. The gas-filled cavity 20 is formed between the outer electrodes 13a, 13b.

The surge arrester 6 is cylinder-shaped (FIG. 4). The surge arrester 6 is formed mirror-symmetrically about a horizontal axis 15 (FIG. 3). Furthermore, the surge arrester 6 is formed mirror-symmetrically about a vertical axis 21 (FIG. 3). The surge arrester 6 has a length of less than or equal to 1.5 cm. For example, the surge arrester 6 has a length of 1.1 cm. The surge arrester 6 has a diameter of less than 1 cm, for example, 0.9 cm.

FIGS. 5 and 6 show a cross-sectional view and a perspective view of the component 10 for protecting against overvoltages, according to an additional embodiment. In FIGS. 5 and 6, the component is depicted without the insulating casing 18 for reasons of clarity. Like the component 10 according to FIG. 2, the component 10 in this embodiment is formed mirror-symmetrically about the horizontal axis 15 and about the vertical axis 21 (FIG. 5).

In contrast to the component 10 described in connection with FIG. 2, here, no insulator 16 is formed between the contact element 17 and the central electrode 12. However, in order to prevent a flashover between the contact element 17 and the central electrode 12, the vertical spacing between the contact element 17 and the central electrode 12 is increased in this embodiment. The vertical spacing is, for example, 2 mm. Due to the increased spacing between the contact element 17 and the central electrode 12, it is possible to effectively compensate for voltages up to 2 kV.

All additional features of the component 10 correspond to the features described in connection with FIG. 2.

The description of the subject matter provided here is not limited to the individual specific embodiments. Rather, the features of the individual embodiments may be combined in any manner, to the extent that this is technically reasonable.

1-14. (canceled)

15. A component for protecting against overvoltages, the component comprising:
a surge arrester;
a first varistor;
a second varistor;
wherein the surge arrester, the first varistor and the second varistor are combined in a single component;
a first connecting element electrically conductively connected to the first varistor; and
a second connecting element electrically conductively connected to the second varistor.

16. The component according to claim 15,
wherein the surge arrester is arranged between the first varistor and the second varistor, and
wherein the first varistor and the second varistor are arranged directly adjacent to the surge arrester.

17. The component according to claim 15, wherein the component is configured to compensate for the overvoltages between at least two of the first connecting element, the second connecting element or a ground conductor, and wherein one of the first and second connecting elements constitutes a phase conductor and the other one of the first and second connecting elements constitutes a neutral conductor.

18. The component according to claim 15, wherein the first varistor and the second varistor are connected in series.

19. The component according to claim 15, further comprising:
a first outer electrode of the surge arrester;
a second outer electrode of the surge arrester;
a central electrode of the surge arrester being arranged between the first outer electrode and the second outer electrode; and
a discharge space of the surge arrester enabling an electrical discharge between the first outer electrode and the central electrode and/or between the second outer electrode and the central electrode in case of an overvoltage.

20. The component according to claim 19,
wherein the first varistor is electrically conductively connected to the first outer electrode, and
wherein the second varistor is electrically conductively connected to the second outer electrode.

21. The component according to claim 15, further comprising a contact element configured to compensate for an overvoltage occurring between the first connecting element and the second connecting element.

22. The component according to claim 21, further comprising a short-circuit bridge of the contact element.

23. The component according to claim 21, further comprising:
a first outer electrode of the surge arrester;
a second outer electrode of the surge arrester;
a central electrode of the surge arrester being arranged between the first outer electrode and the second outer electrode; and
an insulator of the surge arrester configured to prevent a flashover from the contact element to the central electrode.

24. The component according to claim 15, further comprising:
a first outer electrode of the surge arrester;
a second outer electrode of the surge arrester;
a central electrode of the surge arrester arranged between the first outer electrode and the second outer electrode; and
at least one insulating element of the surge arrester configured to prevent an electrically conductive connection between at least two of the first outer electrode, the second outer electrode and the central electrode.

25. The component according to claim 24, wherein the insulating element comprises a ceramic.

26. The component according to claim 15, further comprising an insulating casing, wherein the surge arrester, the first varistor and the second varistor are arranged together inside the insulating casing.

27. The component according to claim 26, further comprising a powder coating of the insulating casing.

28. A component for protecting against overvoltages, the component comprising:
a first varistor;
a second varistor;
a surge arrester arranged between the first varistor and the second varistor, the first varistor and the second varistor being arranged directly adjacent to the surge arrester;
a first connecting element electrically conductively connected to the first varistor; and
a second connecting element electrically conductively connected to the second varistor.
